(19) United States
(12) Patent Application Publication
(10) Pub. No.: US 2002/0163221 A1
(43) Pub. Date: Nov. 7, 2002

(54) Shelter attachment for trucks

(76) Inventor: Lawrence C. Smith, Santa Barbara, CA (US)

Correspondence Address: KOPPEL, JACOBS, PATRICK & HEYBL, SUITE 107, 555 ST. CHARLES DRIVE, THOUSAND OAKS, CA, 91360, US

(21) Appl. No.: 10/112,466

(22) Filed: Mar. 29, 2002

Related U.S. Application Data
(60) Provisional application No. 60/280,301, filed on Mar. 30, 2001.

(51) Int. Cl. B60P 3/345

(52) U.S. Cl. 296/164

(57) ABSTRACT

A shelter for the bed of a pick-up truck is disclosed, which includes a first and second removable rectangular bed lid, and two or more lid braces. Each lid has a hinge connection to a respective sidewall. The lids cover the truck bed when closed and when open each of the lids are supported in the open horizontal position by at least one of the two or more braces. A tent is mounted between the open first and second lids and is erected over the open lids and the truck bed to form a shelter. The lid braces extend between one of the open bed lids and the truck bed and each, alone or in combination with other bed lids, provides sufficient support so that a person can safely sleep on the open lid. The tent is attached to the lids by a “rope girt” arrangement. The shelter can also include an inflatable tube construction that is positioned with the tent to inflate and erect the tent. The invention also includes a sealing strip, which covers the space between the bed lids when they are closed over the bed to reduce water and dirt intrusion into the bed.

This application claims the benefit of provisional application No. 60/280,301 to Smith, which was filed on Dec. 3, 1999.

### BACKGROUND OF THE INVENTION

1. Field of the Invention

This invention relates to trucks and more particularly to tent type shelters for pick-up truck beds.

2. Description of the Related Art

With the popularity of outdoor activities such as camping and the increased number of puck-up trucks, there is an increasing need for comfortable, safe, convenient and affordable truck bed shelters for protection from the wind, rain, cold, etc. Hard-sided campers are commonly installed over the truck's bed to serve as storage and sleeping when camping. One small type of camper, commonly referred to as a camper shell, covers the truck's bed, but does not extend beyond the sides of the bed and does not extend above the roof of the truck's passenger compartment. While affordable, these types of campers have limited storage space. When sleeping, the occupant must lay on the floor of the truck bed, which is uneven and uncomfortable, and the sleeping space is limited by the truck bed wheel wells. Also, these camper shells are not easily removable and replacable.

Larger campers can also be installed on truck beds which can come equipped with sinks, beds, refrigerators and even bathrooms and showers. While comfortable and convenient, these campers are bulky and awkward. They raise the truck's center of gravity making it more susceptible to rollover. They are also very expensive, decrease the truck's fuel efficiency, and are not easily removed.

U.S. Pat. No. 4,093,302 to Adams discloses a camper cover for mounting over the truck bed that includes a frame and an inflatable cover attached to the frame to form the camper cover. U.S. Pat. No. 4,296,960 to Winchester, discloses an inflatable camper for pick-up trucks that is more rectangular shaped and extends over the passenger compartment. U.S. Pat. No. 5,692,795 to Mininger discloses an inflatable tent for the bed of a pick-up having numerous tubs secured parallel to one another to form a U-shaped tent secured to the bed. Like the camper shell described above, these campers only cover the truck bed which limits the camper's space requires the occupant to sleep and the floor of the bed. Also, when these campers are deflated, there is no way to protect the contents of the truck bed.

Tents have been developed to work in conjunction with installed rigid pick-up bed covers. When the cover is lifted there is increased space for sleeping and when the lid is closed the contents of the truck bed are protected. U.S. Pat. No. 5,924,761 to Harrison, discloses a flexible camper tent that is attached to a rigid truck bed cover. The rigid cover is attached by a hinge to the top of the bed's front wall. The tent is attached to the inside of the rigid bed so that a tent is formed when the cover is lifted to its raised position. U.S. Pat. No. 5,957,525 to Nelson, discloses a similar camper tent where a fabric tent is extended from the bottom of the rigid cover when it is open and a pair of support rods mounted to the bottom of the cover support hold the cover in its open position. These campers have the disadvantage of very limited camper space when the tent is up and like above, the occupant must sleep on the uneven floor of the bed.

Other truck bed covers have been developed that comprise frames and flexible material such as canvas. See U.S. Pat. Nos. 4,332,265 to Baker, 4,310,194 to Biller, and 6,000,745 to Alexa). These campers suffer from the same disadvantages as the campers above: limited camping space by not extending over the truck bed's sidewalls, occupants sleeping on the floor of the bed, and no protection for the contents of the bed when the tent is down.

Tent enclosures have also been developed for boats. Taylor Made® has developed a canvas enclosure for the aft cockpit of a typical cruiser, the enclosure having a design similar to a pop-up camping tent. However, this type of enclosure is primarily designed for protection against weather and does not increase the boats sleeping capacity. Also, when the enclosure is down, there is no protection for contents of the cockpit.

### SUMMARY OF THE INVENTION

The present invention provides a shelter that can be removably mounted on the bed of a pick-up truck. Pick-up truck beds have a generally rectangular floor with first and second parallel sidewalls, a front wall, and a rear tailgate capable of being raised and lowered. The truck bed shelter includes a first and second removable bed lid, and two or more lid braces. Each lid has a substantially rectangular shape and a longitudinal edge of the first lid has a first hinge connection to the top of the first sidewall. The longitudinal edge of the second lid has a second hinge connection to the top of the second sidewall. The lids cover the truck bed when closed and when open each of the first and second lids are supported in the open horizontal position by at least one of the two or more braces. A tent structure is mounted between the open first and second lids and is erected over the open lids and the truck bed to form a shelter.

In a preferred embodiment, each of the lid braces extend between one of the open bed lids and the truck bed and each, alone or in combination with other bed lids, provides sufficient support so that a person can safely sleep on the open lid. The braces can also provide support by extending between the open lid and the ground below.

The tent structure is attached to the lids by a “rope girt[ arrangement. Each of the lids has an internal groove along its outside longitudinal edge. The edges of the tent have a rope attached thereto and each of the ropes is housed within a respective internal groove to form the rope girt attachment. To provide for the removal of the shelter, the truck bed further comprises two or more stake pockets arranged on the inside and near the top of its sidewalls. The hinges on the lids have stake pocket insert arranged to be removably inserted onto a respective one of the stake pockets.

The invention also includes a sealing strip, which also uses a rope girt arrangement to attach to the bed lids. It covers the space between the bed lids when they are closed over the bed to reduce water and dirt intrusion into the bed. The strip has two strip ropes, each of which is attached along a respective longitudinal edge of the strip. The strip ropes are housed within the lid grooves when the lids are closed so that the sealing strip extends between the lids, covering the space between the lids.

The shelter can also include an inflatable tube construction that that is arranged to inflate to erect and support the tent structure. Flexible material is included at the ends of the tent to provide an enclosed shelter having an inverted U-shaped cross-section.

The new shelter provides a spacious area over the truck bed, wherein the occupant can sleep on one of the open lids, not on the floor of the truck bed. The shelter provides protection from the sun, wind, rain and insects. In a preferred embodiment the raised tent is not attached to the ground and the truck can easily be moved with the tent up to take advantage of sun, breeze, views, etc. When the shelter is down, the bed lids can be closed, locked and sealed by the sealing strip to protect the bed's contents. When the structure is removed the truck can function as a normal work truck.

The new inflatable tent is safe, convenient, comfortable and affordable. It is lightweight and can easily be erected and lowered by one person. The tent structure is connected to the edge of the open lids to provide a watertight connection between the two. When the tent is deflated the closed lids provide watertight protection for the truck bed.

These and other further features and advantages of the invention would be apparent to those skilled in the art from the following detailed description, taking together with the accompanying drawings, in which:

### BRIEF DESCRIPTION OF THE DRAWINGS

FIG. 1 is a back elevation view of a pick-up truck with a shelter according to the present invention is installed in its bed;

FIG. 2 is a plan view of a pick-up truck of FIG.1 with the lids open and the tent removed;

FIG. 3 is a side elevation view of the pick-up truck in FIG. 1;

FIG. 4 is a sectional view of the connection between one of the bed lids and the tent;

FIG. 5 is a plan view of the a truck with the shelter deflated and removed from the lids and the lids closed;

FIG. 6 is back elevation view of the truck shown in FIG. 5;

FIG. 7 is a sectional view of the connection between the closed lids and a sealing strip;

FIG. 8 shows an elevation view of one of the braces between one of the lids and the truck bed;

FIG. 9 is a perspective view of a device that can be used to removably connect the lids to the truck bed.

### DETAILED DESCRIPTION OF THE INVENTION

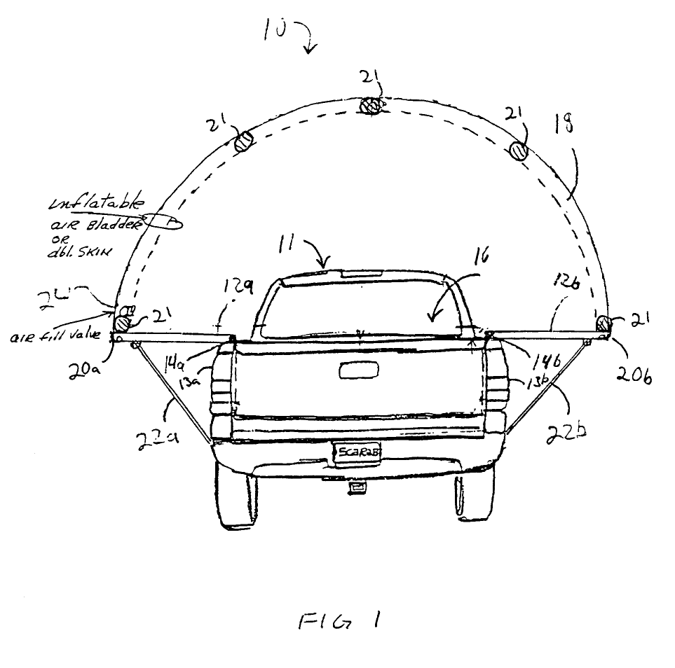

FIGS. 1-3 show a new pickup truck bed shelter 10 constructed in accordance with the present invention. It is mounted on a truck 11 and over its truck bed 16. It includes bed lids 12a, 12b that are shown in the open position with a tent 18. The lids 12a, 12b are each connected to the top edge of the parallel bed sidewalls 13a, 13b by 180° hinges 14a, 14b. The lids 12a, 12b can be rotated between the open position (as shown) and a closed position over the truck bed 16. The tent 18 is attached to the lids 12a, 12b and is erected over the lids 12a, 12b and the bed 16 to form the shelter.

The tent 18 can be erected using many different arrangements with the preferred tent being erected by an inflatable tube construction 21 as more fully described below. The tube construction 21 comprises a number of inflatable tubes assembled in frame having an inverted U-shaped cross-section. The tube construction can be inflatable from a single air valve. The tent edges 20a, 20b attach to the lids 12a, 12b respectively, and many difference attachment methods can be used such as snaps, zippers, buttons, or hooks. A preferred attachment method is by a rope-girt arrangement, which provide a watertight seal between the tent 18 and the lids 12a, 12b. (as more fully described below).

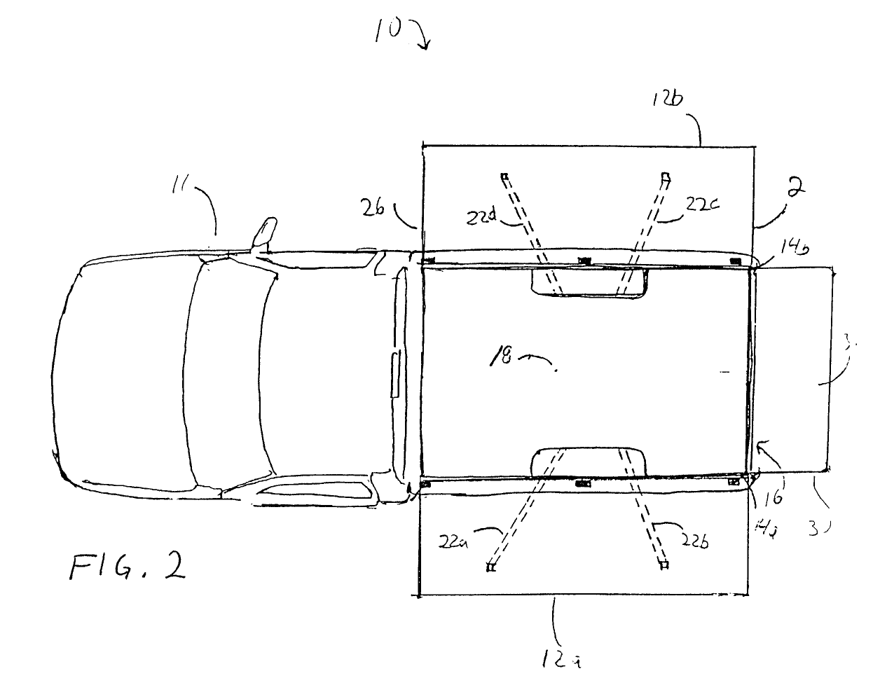

FIG. 2 shows the open lids 12a, 12b (without the tent 18), which are supported by four braces 22a-d. One end of each the braces 22a-d is connected to its respective lid and the other end preferably connected to the to the truck bed 16. Alternatively the braces could provide support by reaching the ground below the lids. The braces could also connect to other parts of the truck 11 including but not limited to its wheels, bumper, fender, suspension, etc.

The tent 18 should be made of a durable and flexable material that can also be waterproof. The ends 26 and 28 of the tent 18 have flexible material that encloses the tent area over the truck bed 16. Windows of a clear flexible material or flexible screens can be included in various locations on the tent 18.

The lids 12a, 12b are preferably equal sized and rectangular shaped, and made of a lightweight, rigid and durable material. A suitable lid is made of a lightweight core that is covered by a gel coat or fiberglass skin. When closed, the lids 12a, 12b meet along the longitudinal centerline of the truck bed 16 and provide a protective cover over the truck bed 16 and its contents.

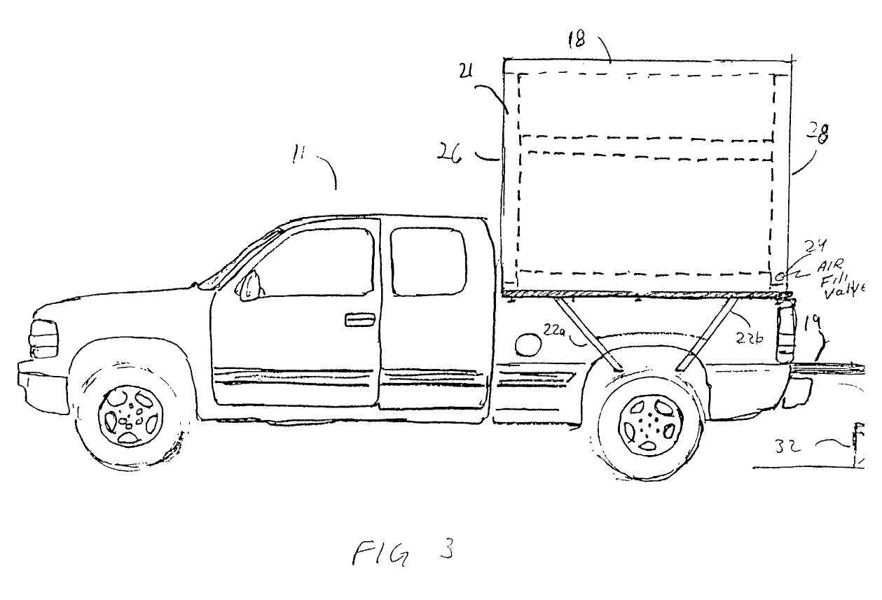

As shown in FIG. 3, when the tent structure 18 is erected, the truck bed's tailgate 19 can be lowered and the shelter 10 is easily entered by stepping up to the tailgate 30. A storage box or cooler 32 or other sturdy and stable items can be used as an intermediate step to the tailgate 19. The tailgate 19 can be closed after the occupant enters the shelter to provide greater security.

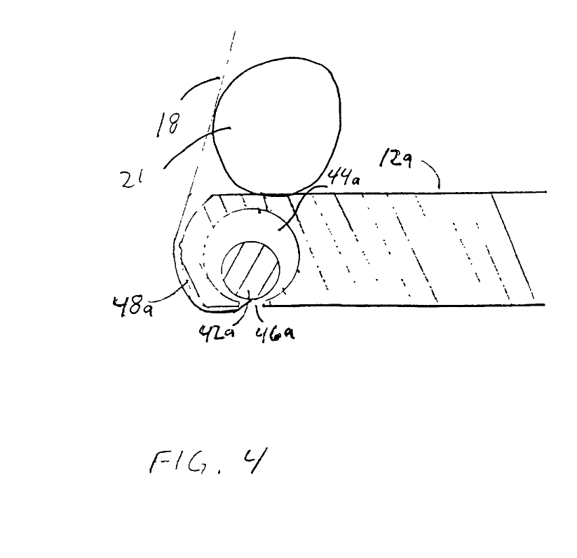

FIG. 4 shows the rope-girt connection between the rope 42a of the tent 18, and the lid 12a, with the rope-girt connection with lid 12b (not shown) being the same. The lid 12 has a internal longitudinal groove 44 running along its longitudinal edge opposite its hinge 14a, with the preferred groove being cylindrical shaped. Each groove has an access slit 46a along its length providing an opening from the surface of the lid to the groove 44a. When the lid is open the access slit faces down. Before inflation of the tube construction 21 in the tent 18, the rope 42a is slid into the groove 44a until the entire rope 42a is housed within the groove 44a. When the tube construction 21 is inflated, the air pressure pulls the tent taught and the tent is pressed against the edge 48a of the lid 12a to provide a watertight connection between the two.

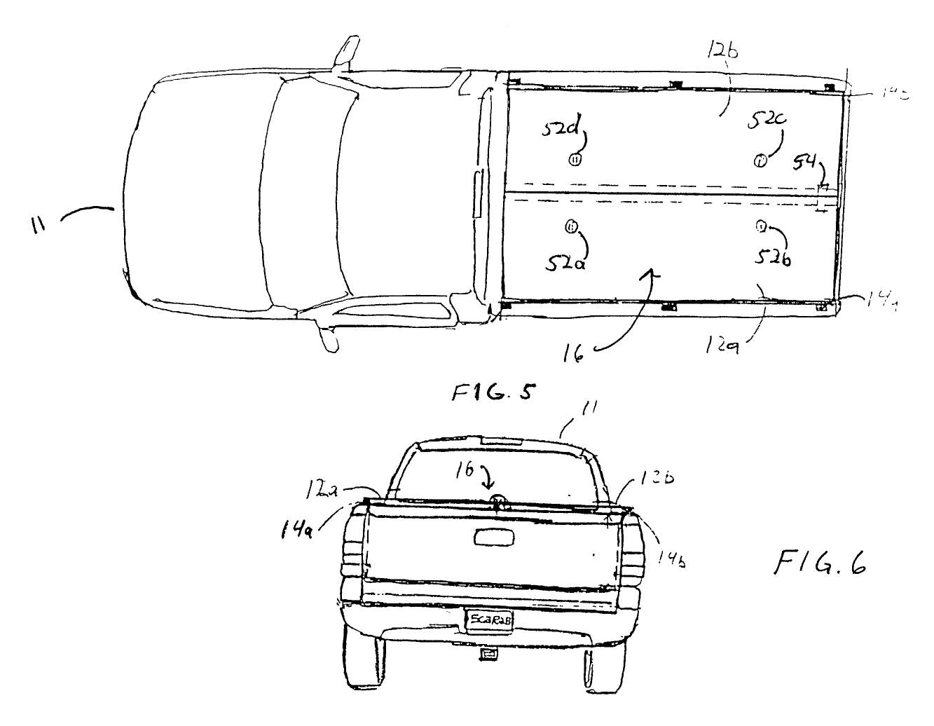

FIGS. 5 and 6 show the truck 11 with the tube construction 21 deflated, the tent 18 removed, the braces 22a and 22b removed, and the lids 12a and 12b rotated about their hinges 14a and 14b to the closed position over the truck bed 16. The edges of the lids 12a and 12b meet on a line along the longitudinal axis of the truck 11. A rubber seal can be included along the top edge of the truck bed walls to provide a watertight seal between the bed 16 and the lids 12a and 12b. The lid connection points 52a-d, where the braces 22a-d connect to the lids 12 and 12b, are visible when the lids are closed. The connection points 52a-d are preferably recessed and include a connection brackets. A lock 54 can be included to lock the lids 12a, 12b in the closed position to protect the contents of the truck bed 16.

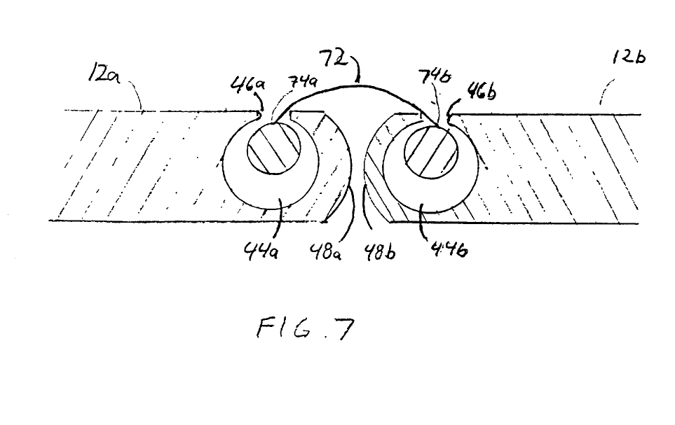

FIG. 7 shows the edges 48a and 48b of the lids 12a and 12b when the lids are closed and show the installation of the sealing strip 72, which is also attached to the lids 12a, 12b by a rope-girt type attachment. The strip 72 is elongated and is preferably made of a water impervious and flexible material that is slightly longer than the truck bed 16. It has ropes 74a and 74b attached to its longitudinal edges. When the lids are closed, the slits 46a and 46b of the grooves 44a and 44b, face up. Rope 74a is slid into tube 44a while at the same time rope 74b is slid into tube 44b. The sealing strip 74 passes through the slits 46a and 46b and covers any space between lid edges 48a and 48b to reduce water or dirt intrusion into the truck bed 16. The end of the sealing strip 72 can extend beyond the end of the lids 12a and 12b and overlap the tailgate 16. The overlap section can attach to the tailgate 16 to secure the sealing strip 72, with a suitable attachment mechanism being a snap.

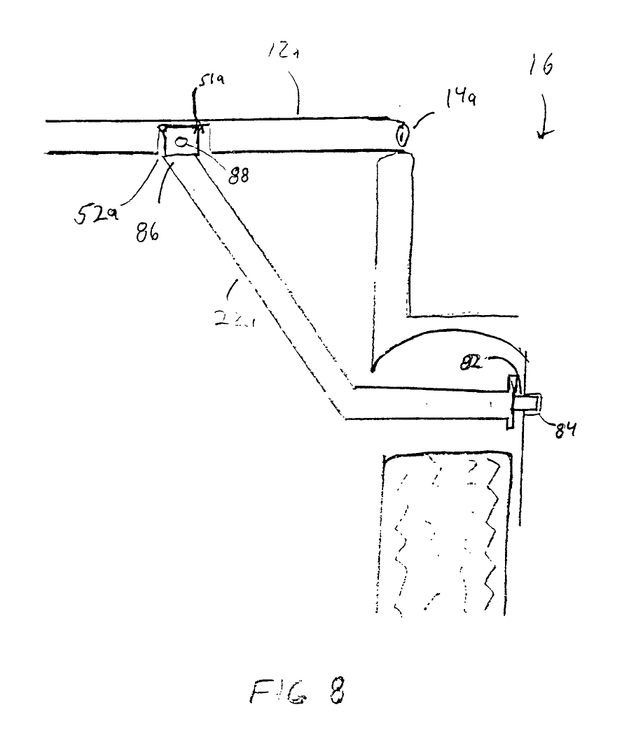

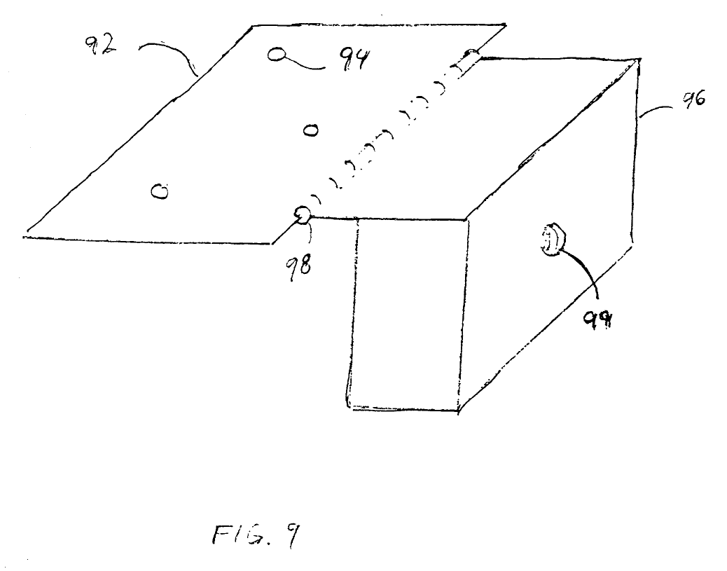

FIG. 8 shows in more detail one of the preferred methods for installing the brace 22a to support the lid 12a, although other methods will also work. The brace 12a has a tongue 82 that is inserted in a slot 84 in the truck's frame. The slot 84 is arranged in the top of a wheel well of the truck bed 16 and as a result, the brace 22a must be angled slightly. In alternative embodiments the slot 84 could be lower in the wheel well and off to a side of the wheel so that the shaft 22a does not need to be angled. The other end 86 of the brace 22a is formed to mate with a bracket 51a in a lid recess 52a, the end 86 has a hole 88 that lines up with a hole in the lid's bracket. A pin 89 can be inserted though the aligned holes to secure the brace 22a to the lid 12a.

FIG. 9 shows a hinge structure 90 that can be used to removably attach the lids 12a and 12b to the truck bed. The structure 90 has a flat rectangular rigid section 92 that is preferably made of a metal. It has three holes 94 for connecting it to one of the lids 12a, 12b. The rigid section 92 is connected to a stake pocket insert 96 by a 180° hinge 98. The stake pocket insert 96 is sized to fit within the stake pockets of the truck bed 16. The structure 90 can be mounted on the edge of a lid to align with and be inserted into the stake pockets. The stake pocket can have a hole that aligns with the threaded insert hole 99 so that a bolt can be inserted through the stake pocket hole and threaded into the insert hole 99 to secure the structure 90 in the stake pocket. To remove the lids 12a and 12b the bolts are removed and the lids are lifted until the stake pocket inserts 96 are pulled from the stake pockets.

To raise the shelter 10 when the lids 12a, 12b are closed, the sealing strip 72 is removed from the lid grooves 44a and 44b. The lids 12a, 12b are then opened and the braces 22a and 22b are connected between their respective lid 12a, 12b and its slot 84 in one the bed's wheel wells. The tent ropes 42a and 42b are inserted into the lid tubes 44a and 44b. The tube construction 21 is positioned with tent 18 and is inflated. The tent storage box or a cooler is placed near the opened tailgate 16 to serve as a step for entering the tent. The braces 22a and 22b provide sufficient support so that the occupant can sit or sleep on the open lids 12a and 12b. The ropes along the edges of the tent 18 are slid into the grooves 44a, 44b. The inflatable tube construction 21 is arranged within the tent 18 and is inflated. The tube construction can be inflated in many different ways including but not limited to manual inflation or inflation by vehicle or standard powered inflation devices.

To lower the shelter 10, the tube construction 21 is deflated and removed from the tent 18. The tent ropes are slid out of the grooves 44a and 44b and the tent is removed from the lids 12a, 12b. The braces 22a-d are removed from the lids 12a, 12b and the lids 12a, 12b are closed over the truck bed 16. The sealing strip 74 can then be mounted in the grooves 44a, 44b.

In an alternative embodiment of the tent and tube construction combination the tubes of the tube construction that are adjacent to the groove edges of the lids 12a, 12b can have the rope girt with a strip of material between the rope girt and tube. Each rope girt is inserted into its respective groove and when the tube construction is inflated, each strip provides a watertight seal with the lid edge. The tent structure is usually placed over the tube construction before it is inflated.

The present invention can also be used to provide shelter in boats. The preferred boat embodiment does not include lids but instead will have the rope girt mate with a tube around the boat's sheer, near its rub rail.

Although the present invention has been described in considerable detail with reference to certain specific implementations, other versions are possible. The tent can take many different shapes and it can connect to the lids or boat in many different ways. Therefore, the spirit and scope of the invention should not be limited to the specific embodiments described in the specification and shown in the drawings.

I claim:

1. A shelter attachment removably mounted to a bed of a pickup truck, said bed having a generally rectangular floor, first and second generally parallel sidewalls, a front wall and a rear tailgate capable of being raised and lowered, said shelter comprising:
two or more lid braces;
first and second removable bed lids, each having a substantially rectangular shape, a longitudinal edge of said first lid having a first hinge connection to the top of said first sidewall and a longitudinal edge of said second lid having a second hinge connection to the top of said second sidewall, said first and second lids covering said truck bed when closed, and each of said first and second lids supported in the open horizontal position by at least a respective one of said two or more braces; and
a tent disposed over said open first and second lids and said truck bed, said tent erected to form a shelter.

2. The shelter of claim 1, further comprising a tube construction disposed within said tent and having inflatable tubes to erect said tent when inflated.

3. The shelter of claim 2, wherein said tent includes first and second attachment edges, each of said first and second edges having attachment means for mounting to said first and second lid respectively.

4. The shelter of claim 3, wherein each of said first and second lids further comprise an internal groove along its longitudinal edge opposite its hinged attachment, each said groove having an access slit along its length, said attachment means comprising a rope along each of said first and second edges, each said rope having a larger cross-section than said slits and each housed within a respective one of said grooves.

5. The shelter of claim 4, wherein each said slit faces down when said first and second lids are open, a portion of said tent held against a longitudinal edge of its respective lid to form a watertight seal when said tent is erected.

6. The shelter of claim 1, wherein said truck bed further comprises two or more brace slots of equal number as said two or more lid braces, each of said two or more lid braces supporting its respective one of said first and second lids by extending between a respective brace slot and said lid.

7. The shelter of claim 6, wherein said truck bed has two wheel wells, each of said two or more brace slots arranged in one of said wheel wells.

8. The shelter of claim 6, wherein said first and second lids have brackets, each of said bracket arranged for attaching to one of said two or more braces.

9. The shelter of claim 1, wherein each said two or more lid braces supports its respective one of said first and second lids by extending between the said lid and the ground below.

10. The shelter of claim 1, wherein each of said first and second hinge connections comprises one or more hinges.

11. The shelter of claim 10, wherein said truck bed further comprises two or more stake pockets, each arranged on the inside and near the top of one of said first and second sidewalls, said one or more hinges each having stake pocket insert arranged to be removably inserted onto a respective one of said stake pockets.

12. The shelter of claim 11, further comprising a means for fixing said stake pocket inserts in said stake pockets.

13. The shelter of claim 1, further comprising a sealing strip with two strip ropes, each of said two strip ropes attached along a respective longitudinal edge of said strip, said lid longitudinal groove edges adjacent to one another when said first and second lids are closed, each of said two strip ropes housed in a respective one of said lid grooves, said sealing strip passing between said lids.

14. The shelter of claim 13, wherein said sealing strip is made of a water-resistant material.

15. The shelter of claim 13, wherein said sealing strip extends beyond said first and second bed lids, said sealing strip further comprises a means for attaching to the top of said rear tailgate when said tailgate is closed.

16. The shelter of claim 1, further comprising a lock arranged to lock the lids in the closed position.

17. A shelter for the bed of a pickup truck, said bed having two sidewalls, a front wall and a tailgate, said shelter comprising:
first and second bed lids, each capable of having a 180° hinge connection to the top one of said two sidewalls to rotate between the open and closed position, said lids covering said truck bed when closed;
a means for supporting said lids in a horizontal position when open to support the weight of at least one person;
a tent disposed over said first and second lids and said bed;
a means for attaching said tent to said to said first and second lids; and
a means for erecting said lid over said over said open first and second lids and said truck bed to form a shelter.

18. The shelter of claim 17, wherein each of said first and second bed lids further comprise a internal groove along its longitudinal edge opposite its hinge connection, each said groove having an access slit along its length, said attachment means comprising a rope along two edges of said tent, each said rope having a larger cross-section than width of said slits and each rope housed within a respective one of said grooves.

19. The shelter, of claim 18, wherein each said slit faces down when said first and second lids are open, a portion of said tent held against a longitudinal edge of its respective lid to form a watertight seal when, said tent is erected.

20. The shelter of claim 17, wherein said support means comprises two or more braces, each said first and second bed lids having at least one of said two or more braces extending between it and said truck bed.

21. The shelter of claim 20, wherein said truck bed further comprises at two or more brace slots equal to the number of said two or more braces, each of said two or more braces supporting its respective lid between a respective brace slot and its lid.

22. The shelter of claim 21, wherein said truck bed has two wheel wells, each of said two or more brace slots arranged in one of said wheel wells.

23. The shelter of claim 17, wherein said support means comprises two or more lid braces, each of said two or more braces extending between one of said first and second and the ground below the lid.

24. The shelter of claim 17, wherein said truck bed further comprises two or more stake pockets arranged near the top of said sidewalls, said hinge connections each having stake pocket insert arranged to be removably inserted onto a respective one of said stake pockets.

25. The shelter of claim 18, further comprising a sealing strip with two strip ropes, each of said two strip ropes attached along a respective longitudinal edge of said strip, said lid groove edges adjacent to one another when said first and second lids are closed, each of said two strip ropes housed in a respective lid groove, and sealing strip passing between said lids.

26. The shelter of claim 25, wherein said sealing strip is made of a water-resistant material.

27. The shelter of claim 25, wherein said sealing strip extends beyond said first and second lids and further comprises a means for attaching to the top of said rear tailgate when said tailgate is closed.

28. A shelter for the bed of a pickup truck, said bed having two sidewalls, a front wall and a tailgate, said shelter comprising:
first and second bed lids, each having a 180° hinge connection to the top one of said two sidewalls, said lids rotatable between the open and closed position, said lids covering said truck bed when closed;
two or more braces, each supporting one of said lids first and second lids in an open horizontal position;
a tent disposed over said first and second lids and said truck bed; and
an inflatable tube construction disposed within said tent and attached to said first and second lids, said tube construction erecting and supporting said tent.

29. The shelter of claim 28, wherein each of said first and second bed lids further comprise a internal groove along its longitudinal edge opposite its hinge connection, each said groove having an access slit along its length, said tube construction attached to said lids by ropes affixed to a lower section of said tube construction, each said rope having a larger cross-section than width of said slits and each rope housed within a respective one of said grooves.

30. The shelter of claim 28, wherein said support means comprises two or more braces, each said first and second bed lids having at least one of said two or more braces
extending between it and said truck bed.
